(19) United States
(12) Patent Application Publication
(10) Pub. No.: US 2026/0099344 A1
(43) Pub. Date: Apr. 9, 2026

(54) CLOUD CLIPBOARD IMPLEMENTATION METHOD, DEVICE, SYSTEM AND STORAGE MEDIUM

(71) Applicant: HANGZHOU ALICLOUD FEITIAN INFORMATION TECHNOLOGY CO., LTD., Zhejiang (CN)

(72) Inventors: Xu ZHANG, Shanghai (CN); Yixin ZHENG, Beijing (CN)

(21) Appl. No.: 19/113,665

(22) PCT Filed: Sep. 19, 2023
(86) PCT No.: PCT/CN2023/119643

§ 371 Date: Mar. 20, 2025

(30) Foreign Application Priority Data
Sep. 20, 2022 (CN) 202211143844.2

(51) Int. Cl. G06F 9/451; G06F 9/50

(52) U.S. Cl. CPC G06F 9/451; G06F 9/5027

(57) ABSTRACT

Embodiments of the present application provide a cloud clipboard implementation method, device, system and storage medium. A global transit center is used to connect multiple working parties in the user workspace, which can realize global accessibility in the cloud office environment, and a user can carry out information and data interaction in its workspace without obstacles, which makes the diverse working parties in the user workspace accessible to each other without obstacles. A centrally-deployed cloud clipboard management and control center is also provided, which is responsible for broadcasting the first event information provided by a working party where a cutting/copying event occurs to other working parties in the user workspace through the global transit center, and is responsible for coordinating the copying of relevant data through the global transit center under the trigger of the working party where the pasting event occurs.

### CROSS-REFERENCE TO RELATED APPLICATIONS

The present application is a National Stage of International Application No. PCT/CN2023/119643, filed on Sep. 19, 2023, which claims priority to Chinese patent application No. 202211143844.2, entitled “CLOUD CLIPBOARD IMPLEMENTATION METHOD, DEVICE, SYSTEM AND STORAGE MEDIUM” and filed with the China National Intellectual Property Administration on Sep. 20, 2022. These applications are incorporated into this application by reference in their entireties.

### TECHNICAL FIELD

The present application relates to the technical field of cloud computing and, in particular, to a cloud clipboard implementation method, device, system and storage medium.

### BACKGROUND

With the continuous enrichment of cloud resources, more and more enterprises choose to join a cloud-based office scenario.

There are a large number of requirements for data copying in the cloud-based office scenario, yet at present, in the cloud-based office scenario, data copying can only be achieved by traditional manners such as “Bluetooth face-to-face transmission”, “using a three-party storage product as an intermediary” and “data redirection”. However, these methods for data copying are inefficient and have their own limitations. For example, “Bluetooth face-to-face transmission” requires that both communication parties have to be terminal devices and the Bluetooth functions are turned on, etc., which leads to low efficiency for data copying in the cloud-based office scenario.

### SUMMARY

Various aspects of the present application provide a cloud clipboard implementation method, device, system and storage medium, for improving the clipping efficiency in a cloud-based office scenario.

Embodiments of the present application provides a cloud clipboard system, including a cloud clipboard management and control center and a plurality of working parties in a user workspace, where the plurality of working parties are accessible to each other through a global transit center;
a first working party in the plurality of working parties, configured to send first event information to the cloud clipboard management and control center through the global transit center in a case that a cutting/copying event which occurs in itself is monitored;
a second working party in the plurality of working parties, configured to send second event information to the cloud clipboard management and control center through the global transit center in a case that a pasting event which occurs in itself is motored after receiving the first event information;
the cloud clipboard management and control center, configured to push received first event information to other working parties except the first working party in the user workspace through the global transit center; and use the global transit center to copy relevant data in the first working party to the second working party in a case of receiving the second event information for the second working party to complete pasting;
where types of the working parties comprise a physical terminal and/or a cloud instance.

Embodiments of the present application further provides a cloud clipboard implementation method, applied to a cloud clipboard management and control device in a cloud clipboard system, where the cloud clipboard system further includes a plurality of working parties in a user workspace, and the plurality of working parties are accessible to each other through a global transit center, the method includes the following steps:
receiving first event information sent by a first working party of the plurality of working parties through the global transit center, where the first event information is sent by the first working party under a condition that a cutting/copying event which occurs in itself is monitored;
pushing the received first event information to other working parties except the first working party in the user workspace through the global transit center;
receiving second event information sent by a second working party of the plurality of working parties through the global transit center, where the second event information is sent by the second working party under a condition that a pasting event which occurs in itself is monitored;
using the global transit center to copy relevant data in the first working party to the second working party in a case of receiving the second event information for the second working party to complete pasting;
where types of the working parties include a physical terminal and/or a cloud instance.

Embodiments of the present application further provide a cloud clipboard implementation method, applied to a plurality of working parties in a user workspace of a cloud clipboard system, wherein the plurality of working parties are accessible to each other through a global transit center, and the cloud clipboard system further includes a cloud clipboard management and control device, the method includes the following steps:
sending first event information to the cloud clipboard management and control center through the global transit center under a condition that a cutting/copying event which occurs in itself is monitored, to enable the cloud clipboard management and control center to push received first event information to other working parties in the user workspace through the global transit center;
using the cloud clipboard management and control center and the global transit center to provide relevant data corresponding to the first event information to a working party where a pasting event which occurs in the user workspace, so as to complete pasting;
sending second event information to the cloud clipboard management and control center through the global transit center under a condition of monitoring the pasting event which occurs in itself, to enable the cloud clipboard management and control center to copy relevant data of the working party where the cutting/copying event occurs in the user workspace to a current working party to complete pasting;
where types of the working parties include a physical terminal and/or a cloud instance.

Embodiments of the present application further provide a cloud clipboard management and control device, including a memory, a processor and a communication component;
the memory is used for storing one or more computer instructions;
the processor is coupled with the memory and the communication component for executing the one or more computer instructions to:
receive, by using the communication component, first event information sent by a first working party in a user workspace in a cloud clipboard system through a global transit center, where the first event information is sent by the first working party under a condition that a cutting/copying event which occurs in itself is monitored;
push received first event information to other working parties except the first working party in the user workspace through the global transit center;
receive, by using the communication component, second event information sent by a second working party in the user workspace through the global transit center, where the second event information is sent by the second working party under a condition that a pasting event which occurs in itself is monitored;
use the global transit center to copy relevant data in the first working party to the second working party under a condition of receiving the second event information for the second working party to complete pasting;
where a plurality of working parties in the user workspace are accessible to each other through the global transit center, and types of the working parties include a physical terminal and/or a cloud instance.

Embodiments of the present application further provide a computing device including a memory, a processor and a communication component;
the memory is used for storing one or more computer instructions;
the processor is coupled with the memory and the communication component for executing the one or more computer instructions to:
send first event information to a cloud clipboard management and control center in a cloud clipboard system through a global transit center under a condition that a cutting/copying event which occurs in itself is monitored, to enable the cloud clipboard management and control center to push the received first event information to other computing devices in a user workspace in the cloud clipboard system through the global transit center;
use the cloud clipboard management and control center and the global transit center to provide relevant data corresponding to the first event information to a computing device in the user workspace where a pasting event occurs, so as to complete pasting;
send second event information to the cloud clipboard management and control center through the global transit center under a condition that the pasting event which occurs in itself is monitored, to enable the cloud clipboard management and control center to copy relevant data in the computing device in the user workspace where the cutting/copying event which occurs to the current computing device to complete pasting;
where a plurality of computing devices in the user workspace are accessible to each other through the global transit center, and types of the computing devices include a physical terminal and/or a cloud instance.

Embodiments of the present application further provide a computer-readable storage medium storing computer instructions which, when executed by one or more processors, cause the one or more processors to execute the aforesaid cloud clipboard implementation method.

In embodiments of the present application, a global transit center is used to connect a plurality of working parties in the user workspace, which can realize global accessibility in the cloud office environment, and a user can carry out information and data interaction in its workspace across terminals, ecology and virtual-physical, which allows the diverse working parties in the user workspace accessible to each other without obstacles. A centrally-deployed cloud clipboard management and control center is also provided, which is responsible for broadcasting first event information provided by a working party where a cutting/copying event occurs to other working parties in the user workspace through the global transit center, and is responsible for coordinating the copying of relevant data through the global transit center under the trigger of the working party where a pasting event occurs. Accordingly, in the embodiments of the present application, global clipping can be realized in the user workspace, which is cross-terminal, cross-ecology, cross-cloud instance, cross-virtual-physical, and cross-region, and the whole cloud clipboard system can help users in enterprises realize a global and efficient clipping experience.

### BRIEF DESCRIPTION OF DRAWINGS

The accompanying drawings described herein are provided to provide a further understanding for the present application and constitute a part of the present application. The illustrative embodiments of the present application and their descriptions are used to explain the present application and do not constitute undue limitations on the present application. In the attached drawings:

FIG. 1 is a schematic structural diagram of a cloud clipboard system provided by an exemplary embodiment of the present application.

FIG. 2 is an exemplary implementation schematic diagram of a global transit center provided by an exemplary embodiment of the present application.

FIG. 3 is a schematic diagram of working logic in an exemplary application scenario provided by an exemplary embodiment of the present application.

FIG. 4 is a schematic flow diagram of a cloud clipboard implementation method provided by another exemplary embodiment of the present application.

FIG. 5 is a schematic flow diagram of another cloud clipboard implementation method provided by another exemplary embodiment of the present application.

FIG. 6 is a schematic structural diagram of a cloud clipboard management and control device provided by another exemplary embodiment of the present application.

FIG. 7 is a structural diagram of a computing device provided by another exemplary embodiment of the present application.

### DESCRIPTION OF EMBODIMENTS

In order to make the purpose, technical scheme and advantages of the present application more clear, the technical scheme of the present application will be described clearly and completely with specific embodiments of the present application and corresponding drawings. Obviously, the described embodiments are only parts of the embodiments of the present application, not the whole embodiments. Based on the embodiments in the present application, all other embodiments obtained by those skilled in the art without creative labor belong to the protection scope of the present application.

At present, efficiency for data copying in the cloud-based office scenario is excessively low. To this end, in some embodiments of the application, a global transit center is used to connect a plurality of working parties in the user workspace, which can realize global accessibility in the cloud-based office environment, and users can interact with information and data in their workspace across terminals, regions, virtual-physical, ecology and cloud instances, which allows the diverse working parties in the user workspace accessible without obstacles. A centralized deployment for the cloud clipboard management and control center is also provided, which is responsible for broadcasting first event information provided by a working party where a cutting/copying event occurs to other working parties in the user workspace through the global transit center, and coordinating the copying of relevant data through the global transit center under the trigger of a working party where a pasting event occurs. Accordingly, in the embodiments of the application, global clipping can be realized in the user workspace, which is cross-terminal, cross-ecology, cross-cloud instance, cross-virtual-physical, and cross-region, and the whole cloud clipboard system can help users in enterprises realize a global and efficient clipping experience.

In the following, the technical scheme provided by each embodiment of the application will be described in detail with the accompanying drawings.

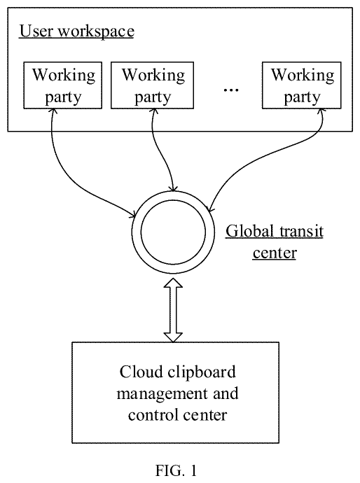

FIG. 1 is a schematic structural diagram of a cloud clipboard system provided by an exemplary embodiment of the present application. As shown in FIG. 1, the system includes a cloud clipboard management and control center and a plurality of working parties in a user workspace, where the plurality of working parties are accessible through a global transit center, and the cloud clipboard management and control center is also accessible to the plurality of working parties through the global transit center.

The cloud clipboard system provided by this embodiment can be applied to the cloud-based office scenario to provide a global and efficient clipping service for the cloud office scenario.

The global transit center in this embodiment can be realized in the form of data bus service, including distributed message processing service and high-speed data transmission service, where the distributed message processing service can support global interaction of messages and/or data, and the high-speed data transmission service can support global interaction of data. Distributed message processing services may include, but are not limited to, message queue MQ service, etc. High-speed data transmission services may include, but are not limited to, object storage OSS services and Network Attached Storage NAS services. In this way, the global transit center in this embodiment can support the global interaction of messages and data, so as to realize the accessibility between multiple working parties in the user workspace and the accessibility between the cloud clipboard management and control center and the plurality of working parties.

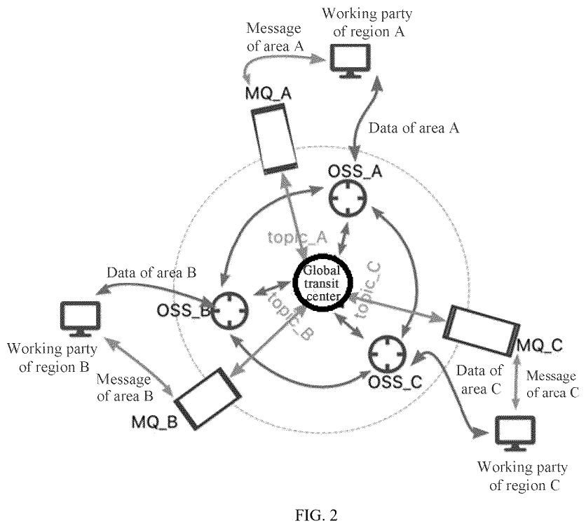

FIG. 2 is an exemplary implementation schematic diagram of a global transit center provided by an exemplary embodiment of the present application. Referring to FIG. 2, in an exemplary implementation principle, a dedicated message topic can be deployed in each region in the cloud, and a working party can associate and use the message queue under the message topic in the region to which he belongs. The global transit center can subscribe to the message topics corresponding to each region. In this way, the global transit center can obtain the messages written by the working parties to their related message topics in time, and route the messages as needed, thus supporting global message interaction. In addition, dedicated storage service areas, such as object storage OSS areas, can also be deployed in each region in the cloud. In this way, the global transit center can support global data interaction with the assistance of the cross-regional backup capability of storage services. Among them, the regions mentioned in this embodiment can be understood as physical data centers in the cloud, and each region is completely independent. In addition, the plurality of working parties in the user workspace may be distributed in different regions.

The user workspace in this embodiment refers to the workspace of a single user in an enterprise. It should be understood that the user workspace in this embodiment is a virtual space rather than a physical space, and centralized management for the working parties used by users can be realized by creating the user workspace. In this embodiment, based on the bottom support of the global transit center, all kinds of working parties that users may use in the office process can be added to the user workspace. In practical application, the plurality of working parties can be added to the same user workspace by logging in with the same user account. Of course, this is only exemplary, and other implementations can be adopted to organize the user workspaces. By setting the user workspace, users in the enterprise can experience the efficient cloud-based office experience of multi-terminal integration, and integrate the rich cloud products on the cloud and the rich offline physical terminals of the enterprise into the user workspace, so that users can use all kinds of working parties in the user workspace without obstacles.

In this embodiment, with the support of the global transit center, the ecology, located region, virtual-physical attribute, etc. of the plurality of working parties in the user workspace can be diverse. Among them, ecology can be understood as an operating system. For example, the ecology of the workplace may include windows ecology, android ecology, apple ecology and so on. Types can be understood as hardware types. For example, the types of working parties may include card machine, all-in-one machine, zero terminal, soft terminal, thin terminal and so on. The virtual-physical attribute can be understood as whether it is generated based on virtualization technology. For example, the working party may be a real physical terminal or a virtualized cloud instance. It should be emphasized here that the cloud instances mentioned in this embodiment are cloud products that need to be accessed based on streaming technology, including but not limited to virtualized cloud desktops, virtualized cloud applications, etc., which are different from those application processes in cloud servers that can log in remotely through ssh software clients, https software clients or web applets. Among them, virtualization cloud desktop is a technology that enables users to remotely access the system desktop on any device through the network after virtualizing the system desktop. Virtualization cloud application is an application virtualization achieved based on desktop virtualization technology, which uses cloud instance resources to run large-scale traditional software and enables users to remotely access large-scale traditional software running on cloud instances on any device. In this embodiment, the cloud instance is in the cloud, specifically, it can be carried on a computing carrier such as a virtual machine or a container in the cloud, and this embodiment does not limit the deployment form of the cloud instance in the cloud.

For example, user A in an enterprise can activate multiple physical terminals and cloud instances as working parties in his user workspace. These physical terminals and cloud instances can be diverse in ecology and their located regions can not be exactly the same, and user A can implement global clipping among online working parties in his user workspace as needed. Users can cut and paste the data on the physical terminal they activate, the data on the virtualized cloud desktop they activate, and the data in the virtualized cloud application they activate.

In addition, it is worth noting that a cloud instance usually needs an interface display terminal as an entrance of human-computer interaction. The interface display terminal can be the local physical terminal of the user, and the soft terminal corresponding to the cloud instance can be run in the interface display terminal, and the cloud instance can provide the content to be displayed to the interface display terminal for display based on streaming technology. In this way, in this embodiment, the physical terminal activated in the user workspace can be used as the interface display terminal of some cloud instances activated by the user, and one physical terminal started in the user workspace can be used as the interface display end of one or more cloud instances at the same time. Of course, the cloud instance activated in the user workspace can also use other physical terminals as interface display terminals, and these other physical terminals do not have to be working parties in the user workspace.

As there are usually two kinds of communication ends involved in the cut-paste operation, that is, an end where a cutting/copying occurs and an end where a pasting occurs. For the convenience of description, in this embodiment, a kind of working party where a cutting/copying event occurs in the user workspace is referred as the first working party. A kind of working party where a pasting event occurs in the user workspace is referred as the second working party. It should be understood that for a certain working party in the user workspace, it may sometimes be the first working party and sometimes it may be the second working party.

Referring to FIG. 1, for the first working party, the first event information can be sent to the cloud clipboard management and control center through the global transit center when a cutting/copying event occurs in itself is monitored.

In this embodiment, a cloud clipboard proxy service can be deployed in the working party, and the working party can use its own cloud clipboard proxy service to monitor its the cutting/copying event and the pasting event occurs in itself.

In a case that the working party is a cloud instance, the process for the working party to monitor the cutting/copying event and the pasting event that occur in itself can be as follows: receiving the operation data synchronized by the interface display terminal connected with the working party, where the operation data is generated when the user operates the peripheral of the interface display terminal, and the interface display terminal is a physical terminal; using the cloud clipboard proxy service to perceive that the operation data includes cutting/copying behavior data, and determining that the cutting/copying event occurs in the working party. Among them, the peripheral of the interface display terminal can be a mouse, a keyboard, etc. For example, the user could execute the pasting behavior through the mouse of the interface display terminal (for example, right-click to call up a menu and click “Paste”), and communication protocols such as USB redirection protocol are pre-agreed between the interface display terminal and the cloud instance in the cloud, so that the interface display terminal can synchronize the operation data including the pasting behavior data to the cloud instance in the cloud when it is monitored that the user is executing the pasting behavior within the display interface of the corresponding party of the cloud instance through its peripherals. For example, the click data of the mouse connected to the display operator is mapped to the virtual mouse in the cloud instance. In this way, the local system clipboard in the guest system of the cloud instance can receive the operation data provided by the interface display terminal and thus perceive the pasting behavior. In this embodiment, the cloud clipboard proxy service deployed in the cloud instance can monitor the pasting behavior in the local system clipboard of the cloud instance and generate a pasting event, and similarly, it can also monitor the cutting/copying behavior and generate a cutting/copying event.

In a case that the working party is a physical terminal, the process for the working party to monitor the cutting/copying event and pasting event that occur in itself can be as follows: perceiving, through its local system clipboard, the operation data corresponding to the cutting/copying behaviors and pasting behaviors conducted by the user via its peripheral, and generating the cutting/copying events and pasting events.

In an implementation, the cloud clipboard proxy service can be implemented as a monitoring process in the operating system, so that the monitoring process can be run in the operating system (such as the terminal system of the physical terminal, the guest system of the cloud instance, etc.) of the working party for monitoring the events of the local system clipboard. Based on this, for the first working party, the cloud clipboard proxy service running on it can be used to monitor its own cutting/copying events. Of course, the first working party can also use the cloud clipboard proxy service running on the first working party to generate the first event information corresponding to the cutting/copying event. The first event information can be used to describe the attributes of the cutting/copying event. The first event information can include, but is not limited to, the information of the working party where the event occurred, the event occurrence time, the event type, the identification, specifications and storage location of relevant data of the event, etc. The first working party can also use the cloud clipboard proxy service running on it to send the first event information to the cloud clipboard management and control center through the global transit center. Following the exemplary implementation principle of the global transit center provided in FIG. 2, the first working party can send the first event information to the message queue under the first message topic associated with the first working party, so as to transmit the first event information to the global transit center, this is because that the global transit center has subscribed to the first message topic. The global transit center can also forward the first event information to the cloud clipboard management and control center, where the cloud clipboard management and control center can subscribe to the message topics in a region it belongs to, and the global transit center can route the first event information to the message queue under the message topics subscribed by the cloud clipboard management and control center, so that the cloud clipboard management and control center can receive the first event information in time.

On this basis, referring to FIG. 1, the cloud clipboard management and control center can push the received first event information to other working parties in the user workspace except the first working party through the global transit center. Among them, multiple working parties in the user workspace are understood as online working parties under the user name. Each working party under the user name can register in the cloud clipboard management and control center in advance, and report its running status in time, so that the cloud clipboard management and control center can accurately perceive which working parties are in the user workspace. Based on this, the cloud clipboard management and control center can determine in real time which other working parties are in the user workspace besides the first working party, and generate routing information for these other working parties and provide the routing information to the global transit center. For the global transit center, it can know how to route the first event information. In an implementation, the routing information provided to the global transit center may include information such as the region to which the working party belongs or the message topic associated with the working party. Based on this, the global transit center can route the first event information to the message queue under the message topics associated with other working parties, so that other working parties can automatically receive the first event information by subscribing to their associated message topics.

It can be seen that in this embodiment, the first event information provided by the first working party can be broadcast to other working parties in the user workspace based on the bus capability of the global transit center and the coordination capability of the cloud clipboard management and control center. In this way, other working parties in the user workspace can receive the first event information.

Continuing to refer to FIG. 1, for the second working party, after receiving the first event information, it can monitor whether a pasting event has occurred in itself. Following the cloud clipboard proxy service deployed in the previous working party, here, the second working party can use the cloud clipboard proxy service running on it to listen to the pasting event. In an implementation, the second working party can start the callback function for the pasting event after receiving the first event information; trigger a callback function to generate second event information, in a case that a pasting event which occurs in itself is monitored. The callback function can be registered by the aforementioned cloud clipboard proxy service. The second event information can be used to describe the attributes of the pasting event, where the second event information can include but not limited to the information of the working party where the event occurred, the event occurrence time, the event type or the identification of relevant data of the event.

In addition, after receiving the first event information, the second working party can obtain the ownership of its local system clipboard, and is ready to handle the pasting event that occurs on the second working party.

On this basis, the second working party can send the second event information to the cloud clipboard management and control center through the global transit center under the condition that a pasting event which occurs in itself after listening to the received first event information. Following the exemplary implementation principle of the global transit center provided in FIG. 2, the second working party can send the second event information to the message queue under the second message topic associated with the second working party, so as to transmit the second event information to the global transit center, as the global transit center has subscribed to the second message topic. The global transit center can also forward the second event information to the management and control center for the cloud clipboard, where the cloud clipboard management and control center can subscribe to the message topic in a region it belongs to, and the global transit center can route the second event information to the message queue under the message topic subscribed by the cloud clipboard management and control center, so that the cloud clipboard management and control center can receive the second event information in time.

For the cloud clipboard management and control center, in a case that the second event information is received, the global transit center can be used to copy the relevant data of the first working party to the second working party for the second working party to complete pasting.

In this process, as multiple second event information may coexist in the cloud clipboard system, the cloud clipboard management and control center can be used to determine the corresponding replication source end of each second event information. Here, for the convenience of description, the replication source end corresponding to the current second event information is the aforementioned first working party by default, but it should be understood that the corresponding copy source ends may not be exactly the same for different second event information. On this basis, under the condition that the cloud clipboard management and control center can receive the second event information, and sends a data upload instruction to the first working party through the global transit center, so as to trigger the first working party to write relevant data into its associated first storage location.

Here, following the exemplary implementation principle of the global transit center provided in FIG. 2, the first storage location may be a message queue under the first message topic associated with the first working party, or it may be a first storage service area set in the region to which the first working party belongs. On this basis, for the first working party, whether the specification of the relevant data of the first event information is less than the preset standard can be determined after receiving the data upload instruction, and if yes, the relevant data can be written into the message queue under the first message topic associated with the first working party in response to the data upload instruction. If the specification of the relevant data of the first event information is not less than the preset standard, the first working party can respond to the data upload instruction and write the relevant data into the first storage service area associated with the first working party. For example, the first object storage the OSS area, etc. Among them, the preset standard can be the maximum data specification that the message queue can carry. In this way, when the specification of relevant data is relatively small, the message queue can be used for data interaction, while when the specification of relevant data is relatively large, the storage service area can be used for data interaction.

In addition, the cloud clipboard management and control center can store the upload record information corresponding to the relevant data of the first event information, where the upload record information can include but not limited to the upload time of the data, the identification of the working party that uploaded the data, the storage location of the data, and so on. Based on the upload record information, the cloud clipboard management and control center can first determine whether the upload task of relevant data has been completed after receiving the second event information. If the upload task has been completed, the cloud clipboard management and control center does not need to issue a data upload instruction to avoid repeated data uploading.

After that, the global transit center can copy the relevant data in the first storage location to the second storage location associated with the second working party. Following the exemplary implementation principle of the global transit center provided in FIG. 2, similar to the first storage location, the second storage location may be a message queue under a second message topic associated with the second working party, or it may be a second storage service area set in the region to which the second working party belongs. On this basis, if the type of the first storage location is message queue, the global transit center can route the relevant data to the message queue under the second message topic associated with the second working party. If the type of the first storage location is a storage service area, the global transit center can route the relevant data to a second storage service area set in the region where the second working party belongs, for example, the second object storage OSS area. Among them, in the case of data interaction through the storage service area, the global transit center can drive the first storage service area to copy the relevant data to the second storage service area at a high speed through the data upload instruction sent to the first storage service area by virtue of the cross-regional replication capability of the storage service, and upload and copy can be conducted at the same time.

The cloud clipboard management and control center can also send a data download instruction to the second working party through the global transit center, so as to trigger the second working party to download relevant data from its associated second storage location. Among them, the global transit center can provide copy record information to the cloud clipboard management and control center, where the copy record information can be used to describe the copy results of data, and the copy record information could include but not limited to the copied location of data, the copy completion time of data, the identification of the working party that uploaded the data, etc. The copy record information can be carried in the data download instruction.

On this basis, the second working party can access the second storage location in response to the data download instruction, so as to download the relevant data to be pasted. In addition, as mentioned above, the second working party has taken over the right to use its local system clipboard, thus the second working party can write the downloaded relevant data into the cache corresponding to its local system clipboard to complete the pasting. Following the callback function registered in the second working party mentioned above, the callback function for the first event information could be ended after pasting in the second working party is completed.

To sum up, in this embodiment, the global transit center can be used to connect a plurality of working parties in the user workspace, which can realize global accessibility in the cloud office environment, and users can interact with information and data in their workspace across terminal, region, ecology, virtual-physical, and cloud instances, which makes the diverse working parties in the user workspace accessible without any obstacle. A centralized deployment of cloud clipboard management and control center is also provided, which is responsible for broadcasting the first event information provided by the working party where the cutting/copying events occurs to other working parties in the user workspace through the global transit center, and coordinating the copying of relevant data through the global transit center under the trigger of the working party where a pasting event occurs. Accordingly, in the embodiment of the application, global clipping can be realized in the user workspace, which is cross-terminal, cross-ecology, cross-cloud instance, cross-virtual-physical, and cross-region, and the whole cloud clipboard system can help users in enterprises realize a global and efficient clipping experience.

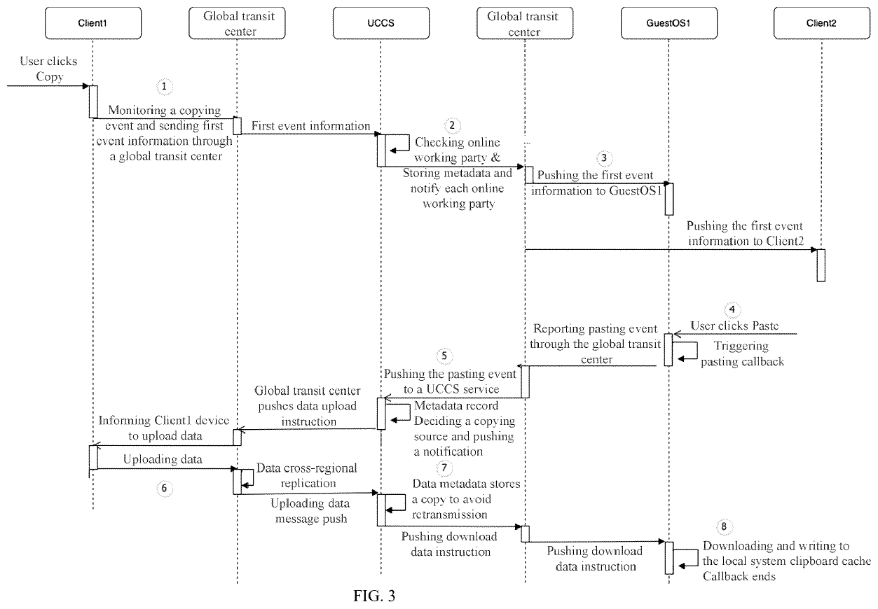

FIG. 3 is a schematic diagram of work logic in an exemplary application scenario provided by an exemplary embodiment of the present application. Referring to FIG. 3, there are multiple working parties in the user workspace. Assuming that the first working party is a physical terminal, the second working party is a cloud instance, and the first working party is the interface display terminal of the second working party, the first working party can send the first event information to the cloud clipboard management and control center through the global transit center under the condition of monitoring the user's cutting/copying behavior outside the display interface of the second working party through its peripherals, so as to push the first event information to the second working party. In the case of monitoring that the user performs pasting behavior within the display interface of the second working party through its peripherals, the operation data including pasting behavior data is synchronized to the second working party, so that the second working party can monitor the pasting events that occur in itself and trigger the pasting of the local data of the first working party into the second working party by sending the second event information to the cloud clipboard management and control center.

Referring to FIG. 3, the physical terminal client1 can be used as the first working party and the cloud instance GuestOS1 is used as the second working party. Of course, the user workspace in FIG. 3 can also include other working parties, such as the physical terminal client2. On this basis, referring to FIG. 3, the working logic is roughly as follows.
1. When a user performs a copying operation on Client1 (outside the display interface corresponding to the cloud instance), the cloud clipboard proxy service (Agent) on Client1 captures the trigger of the copying event and reports the event to the cloud clipboard management and control center (UCCS) through the global transit center.
2. UCCS stores the meta data of the copy event, collects the information of the user's online working party, and pushes the replication event to other online working parties of the user.
3. Client2 and GuestOS1 currently online receive the copying event, obtain the ownership of the local system clipboard, and register a callback function to intercept the pasting event.
4. If the user performs pasting behavior in the interface display terminal corresponding to the cloud instance on Client1, Client1 can map the operation data to the local system clipboard in the cloud instance GuestOS1, and the cloud clipboard proxy service on the cloud instance GuestOS1 can trigger the pasting callback function, so that a pasting event can be generated and reported to the UCCS.
5. UCCS determines that Client1 has not uploaded data, and needs to remotely copy the relevant data on Client1, thus, it will push the data upload instruction to Client1 through the global transit center.
6. Client 1 receives the data upload instruction, uploads the data to the data bus, and the data bus starts to upload and copy across regions simultaneously, and sends the data upload record to UCCS.
7. UCCS stores a copy of data upload record in the database to prevent that multi-terminal repeated pasting requires that data being uploaded repeatedly, and then issues a data download instruction to the cloud instance GuestOS1, and pushes the metadata of the downloaded data to the cloud instance GuestOS1.
8. The cloud instance GuestOS1 receives the data download instruction, accesses the data bus service in the local area, downloads the data at high speed, writes the downloaded data into the local system clipboard cache, ends the paste callback, and the paste operation is completed.

In combination with the schematic diagram of the exemplary implementation of the global transit center provided in FIG. 2, it is assumed that the physical terminal client1, the physical terminal client2 and the cloud instance GuestOS1 are located at a region A, the region B and the region C respectively. A set of MQ service and high-speed storage service OSS are deployed in regions A, B and C respectively. The services in each region are suffixed by regions, such as MQ_A and OSS_A, and the terminal in each region chooses the service access in a nearest region.

On this basis, the global transit center can make use of the cross-regional real-time replication ability of distributed MQ services and OSS services. Specifically, the global transit capability can be embodied as follows: when a replication event occurs in Client1 in region A, the first event information can be sent to the topic_A message queue of MQ_A service in region A, and the global transit center can obtain the first event information by subscribing to MQ_A service in A domain. UCCS can inform the global transit center of the route information of other online working parties in the user workspace, so the global transit center can route the first event information to the topic_B message queue of MQ_B service in B region where pasting may occur. Client2 in region B can receive the first event information routed by the global transit center because it subscribes to the topic_B of MQ_B in B region. The global transit center also routes the first event information to the topic_C message queue of MQ_C service in region C where pasting may need to occur. Similarly, GuestOS1 in area C can also receive the first event information.

When the replication source end client1 needs to upload a large file, the cloud clipboard Agent service (agent) in the client1 determines that the data size exceeds the maximum upper limit of MQ message transmission, and uploads the data to the OSS_A service in region A, and at the same time, the global transit center determines that the pasting event occurred on the GuestOS1 in the region C, so with the help of the capability of cross-regional backup while uploading through the OSS service, and sends an instruction to OSS_A service to copy the file to OSS_C service in region C at high speed, so that GuestOS1 accessing service of region C can download this large file at high speed through OSS_C service.

Therefore, the whole cloud clipboard system can help enterprise users realize a global and efficient clipping experience.

In another case, it is also possible that a cutting/copying event occurs in the cloud instance GuestOS1, and a pasting event occurs in the physical terminal Client1. In this case, the cloud instance GueatOS1 can act as the first working party to execute the processing logic about the first working party, such as generating the first event information, uploading data, etc. Client1, the physical terminal, can act as the second working party to execute the processing logic of the second working party mentioned above, such as generating the second event information, downloading data, etc., so that the data on the cloud instance in the user workspace can be copied to the physical terminal in the user workspace.

Of course, it should be understood that the first working party and the second working party are not limited as one being virtual device and one being physical device, but could both being cloud instances at the same time or both being physical terminal at the same time. This embodiment is not limited to the application scenario provided in FIG. 3. However, in the case that the first working party is a physical terminal and the second working party is a cloud instance, the second working party business does not have to use the first working party as the interface display terminal, but can choose an appropriate interface display terminal as needed. In this way, the first working party and the second working party may be distributed in different region, may adopt different ecosystems, may be physical terminal and cloud instance respectively, and may be different cloud instances. Therefore, in this embodiment, global clipping cross-ecology, cross-regional, cross-virtual-physical and cross-cloud instances in the user workspace can be achieved.

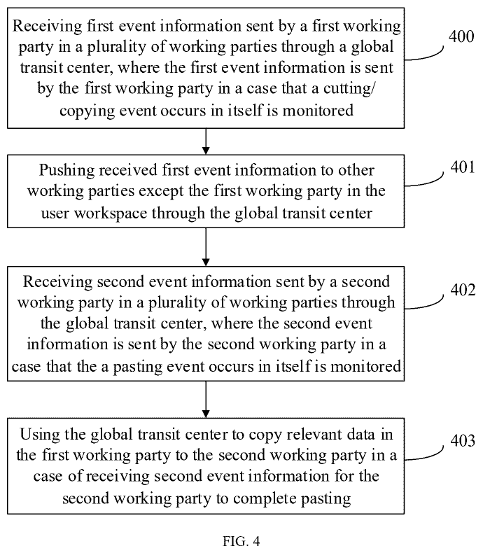

FIG. 4 is a flow diagram of a cloud clipboard implementation method provided by another exemplary embodiment of the present application, which is applied to cloud clipboard management and control device in a cloud clipboard system, where the cloud clipboard system also includes a plurality of working parties in a user workspace, and the plurality of working parties are accessed through a global transit center. Referring to FIG. 4, the method includes:

Step 400: receiving first event information sent by a first working party in a plurality of working parties through a global transit center, where the first event information is sent by the first working party in a case that a cutting/copying event occurs in itself is monitored;

Step 401: pushing received first event information to other working parties except the first working party in the user workspace through the global transit center;

Step 402: receiving second event information sent by a second working party in a plurality of working parties through the global transit center, where the second event information is sent by the second working party in a case that the a pasting event occurs in itself is monitored;

Step 403: using the global transit center to copy relevant data in the first working party to the second working party in a case of receiving second event information for the second working party to complete pasting.

Among them, the types of working parties include physical terminals and/or cloud instances.

In an embodiment, a cloud clipboard proxy service is deployed in the working party, and the working party uses its own cloud clipboard proxy service to monitor cutting/copying events and pasting events which occur in itself.

In an embodiment, the first working party sends the first event information to the message queue under the first message topic associated with the first working party, so as to transmit the first event information to the global transit center, and the global transit center has subscribed to the first message topic; Step 401 may include:
generating routing information for other working parties in the user workspace and provide the routing information to the global transit center;
using the global transit center to route the first event information to the message queue under the message topic each associated with other working parties according to the routing information, so that other working parties receive the first event information by subscribing to the message topic.

In an embodiment, message topics are deployed in different regions respectively, and the working party is associated with the message topics deployed in a region where the working party is located, and multiple working parties can be distributed in totally different regions.

In an embodiment, after receiving the first event information, the second working party starts the callback function for the pasting event; triggers a callback function in response to the pasting operation in the second working party to generate second event information.

In an embodiment, step 403 may include:
sending a data upload instruction to the first working party through the global transit center to trigger the first working party to write relevant data into its associated first storage location;
copying relevant data in the first storage location to the second storage location associated with the second working party through the global transit center;
sending a data download instruction to the second working party through the global transit center to trigger the second working party to download relevant data from its associated second storage location.

In an embodiment, the first storage location is the object storage OSS area set in the region where the first working party is located or the message queue under the first message topic associated with the first working party. The second storage location is the object storage OSS area set in the region where the second working party is located or the message queue under the second message topic associated with the second working party.

In an embodiment, if specification of the relevant data of the cutting/copying event occurs in the first working party itself is less than the preset standard, the first working party responds to the data upload instruction and writes the relevant data into the message queue under the first message topic associated with the first working party, so as to transfer the relevant data to the message queue under the second message topic associated with the second working party through the cloud clipboard management and control center and the global transit center. If specification of the relevant data of the cutting/copying event occurs in the first working party itself is not less than the preset standard, the relevant data is written into the first OSS area associated with the first working party in response to the data uploading instruction, so as to trigger the first OSS area to copy the relevant data into the second OSS area associated with the second working party through the global transit center.

In an embodiment, the global transit center sends the upload record information of the relevant data to the cloud clipboard management and control center; the method further includes the following steps: under the condition of receiving the second event information, determining whether there is upload record information in the relevant data corresponding to the second event information, and if yes, skip sending a data upload instruction to the first working party.

In an embodiment, the second working party writes the obtained relevant data into the local system clipboard cache to complete the pasting.

It is worth noticing that the above technical details of the cloud clipboard implementation method in various embodiments can refer to the relevant descriptions of the cloud clipboard management and control center in the aforementioned system embodiments, which are not repeated here for the sake of conciseness, but this should not cause any loss of the protection scope of this application.

FIG. 5 is a flowchart of another cloud clipboard implementation method provided by another exemplary embodiment of the present application. The method is applied to a plurality of working parties in a user workspace in a cloud clipboard system, and multiple working parties are accessible to each other through a global transit center, and the cloud clipboard system also includes a cloud clipboard management and control device. Referring to FIG. 5, the method may include:

Step 500: sending first event information to the cloud clipboard management and control center through the global transit center in the case that a cutting/copying event occurs in itself is monitored, to enable the cloud clipboard management and control center to push received first event information to other working parties in the user workspace through the global transit center;

Step 501: providing relevant data corresponding to the first event information to a working party in the user workspace where a pasting event occurs using the cloud clipboard management and control center and the global transit center, so as to complete pasting;

Step 502: sending a second event message to the cloud clipboard management and control center through the global transit center in a case that a pasting event occurs in itself is monitored, to enable the cloud clipboard management and control center to copy the relevant data of the working party in the user workspace where the cutting/copying event occurs to a current working party to complete the pasting.

Among them, the types of working parties include physical terminals and/or cloud instances.

In an embodiment, a cloud clipboard proxy service is deployed in the working party, and the working party uses its own cloud clipboard proxy service to monitor cutting/copying events and pasting events which occur in itself.

In an embodiment, the step of sending the first event information to the cloud clipboard management and control center through the global transit center may include:
sending the first event information to the message queue under the message topic associated with the working party, so as to transmit the first event information to the global transit center, where the global transit center has subscribed to the message topic;
where the cloud clipboard management and control center provides the routing information of other working parties in the user workspace to the global transit center; using the global transit center to route the first event information to the message queue under each the message topic associated with other working parties, so that other working parties receive the first event information by subscribing to the message topic.

In an embodiment, message topics are respectively deployed in different regions, and working parties are associated with the message topics deployed in regions where the working parties are located, and multiple working parties can be distributed in regions not exactly the same.

In an embodiment, in a case of receiving the second event information, the cloud clipboard management and control center sends a data upload instruction to the current working party through the global transit center, so as to trigger the current working party to write relevant data into its associated first storage location. Relevant data in the first storage location is copied to the second storage location associated with the working party which sent out the second event information through the global transit center. A data download instruction is sent to the working party through the global transit center to trigger the working party to download relevant data from its associated second storage location.

In an embodiment, the first storage location is the object storage OSS area set in the region where the current working party is located or the message queue under the first message topic associated with the first working party. The second storage location is the object storage OSS area set in the region where the working party initiating the second event information is located or the message queue under the second message topic associated with the second working party.

In an embodiment, the method further includes:
if the specification of the relevant data of cutting/copying event occurs in itself is less than a preset standard, responding to the data upload instruction, writing the relevant data into the message queue under the first message topic associated with the first working party, so as to transfer the relevant data to the message queue under the second message topic associated with the second working party through the cloud clipboard management and control center and the global transit center;
if the specification of the relevant data of cutting/copying event occurs in itself is not less than the preset standard, writing the relevant data into the first OSS area associated with the first working party in response to the data upload instruction, so as to trigger the first OSS area to copy the relevant data into the second OSS area associated with the second working party through the global transit center.

In an embodiment, the global transit center sends the upload record information of the relevant data to the cloud clipboard management and control center; in a case of receiving the second event information, the cloud clipboard management and control center determines whether there is upload record information in the relevant data corresponding to the second event information, and if yes, skip sending data upload instruction to the first working party.

In an embodiment, the method further includes:
after receiving the event information corresponding to the cut/copy event sent by other working parties, starting a callback function for the pasting event;
in response to the pasting operation occurs in the current working party, triggering the callback function to generate event information corresponding to the pasting event.

In an embodiment, the method further comprises:
if a pasting event occurs in the current working party, writing the obtained relevant data into the local system clipboard cache to complete the pasting.

It is worth noticing that the above technical details in the cloud clipboard implementation method in various embodiments can refer to the relevant descriptions of the first working party/the second working party in the aforementioned system embodiments, which are not repeated here for the sake of conciseness, but this should not cause any loss of the protection scope of this application.

It should be noted that in some processes described in the above embodiments and the accompanying drawings, a plurality of operations which appear in a specific order are included, but it should be clearly understood that these operations may be executed out of the order in which they appear here or be executed in parallel. The serial numbers of the operations, such as 401 and 402, are only used to distinguish different operations, and the serial numbers themselves do not represent any execution order. In addition, these processes may include more or fewer operations, and these operations may be performed sequentially or in parallel. It should be noted that the descriptions of “first” and “second” in this paper are used to distinguish different storage locations, working parties, event information, etc., and do not represent the sequence, nor do they limit that “first” and “second” refer to different types.

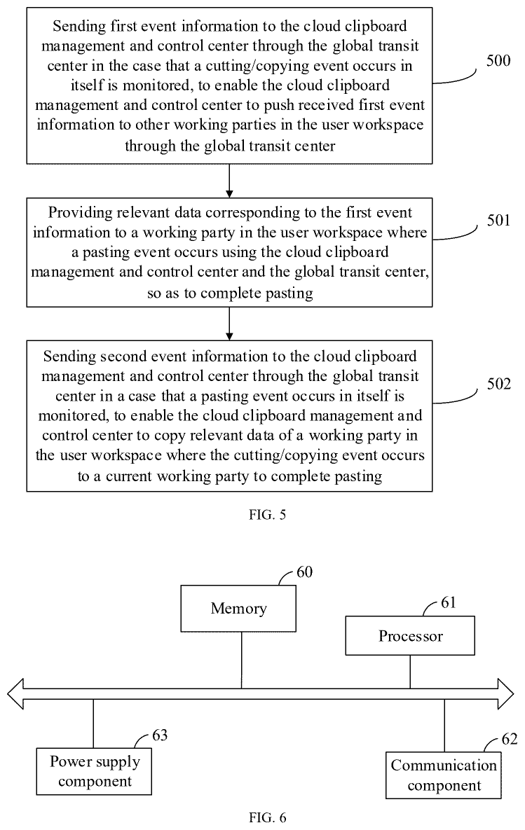

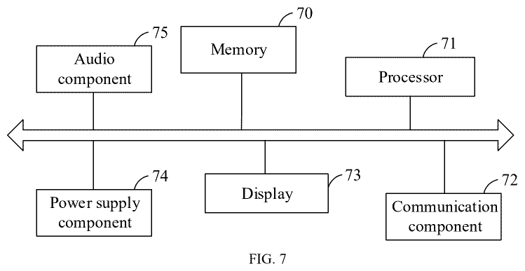

FIG. 6 is a schematic structural diagram of a cloud clipboard management and control device provided by another exemplary embodiment of the present application. As shown in FIG. 6, the computing device includes a memory 60, a processor 61 and a communication component 62.

The processor 61, coupled with the memory 60 and the communication component 62, is used for executing a computer program in the memory 60 for:
receiving, by the communication component 62, first event information sent by the first working party in the user workspace in the cloud clipboard system through a global transit center, where the first event information is sent by the first working party under a condition that a cutting/copying event occurred in itself is monitored;
pushing received first event information to other working parties except the first working party in the user workspace through the global transit center;
receiving, by the communication component 62, the second event information sent by the second working party in the user workspace through the global transit center, where the second event information is sent by the second working party under the condition that a pasting event occurs in itself is monitored;
in a case that the second event information is received, using the global transit center to copy relevant data in the first working party to the second working party for the second working party to complete pasting;
where the plurality of working parties in the user workspace are accessible to each other through the global transit center, and the types of the working parties include physical terminals and/or cloud instances.

In an embodiment, a cloud clipboard proxy service is deployed in the working party, and the working party uses its own cloud clipboard proxy service to monitor cut/copy events and pasting events which occur in itself.

In an embodiment, the first working party sends the first event information to the message queue under the first message topic associated with the first working party, so as to transmit the first event information to the global transit center, where the global transit center has subscribed to the first message topic. In the process of copying the relevant data from the first working party to the second working party by using the global transit center for the second working party to complete the pasting, the processor 61 can be configured for:
providing the routing information of other working parties in the user workspace to the global transit center;
routing the first event information to the message queue under the message topic each associated with other working parties by using the global transit center according to the routing information, so that other working parties can receive the first event information by subscribing to the message topic.

In an embodiment, message topics are deployed in different regions, and working parties are associated with the message topics deployed in regions where the working parties are located, and the plurality of working parties can be distributed in regions not exactly the same.

In an embodiment, after receiving the first event information, the second working party starts the callback function for the pasting event. In response to the paste operation in the second working party, a callback function is triggered to generate the second event information.

In an embodiment, in a process of copying the relevant data in the first working party to the second working party by using the global transit center, the processor 61 can be used for:
Sending a data upload instruction to the first working party through the global transit center to trigger the first working party to write relevant data into its associated first storage location;
Copying the relevant data in the first storage location to the second storage location associated with the second working party through the global transit center;
Sending a data download instruction to the second working party through the global transit center to trigger the second working party to download relevant data from its associated second storage location.

In an embodiment, the first storage location is the object storage OSS area set in the region where the first working party is located or the message queue under the first message topic associated with the first working party. The second storage location is the object storage OSS area set in the region where the second working party is located or the message queue under the second message topic associated with the second working party.

In an embodiment, if the specification of the relevant data of cutting/copying event which occurs in the first working party is less than a preset standard, in respond to the data upload instruction, the relevant data is written into the message queue under the first message topic associated with the first working party, so as to transfer the relevant data to the message queue under the second message topic associated with the second working party through the cloud clipboard management and control center and the global transit center. If the specification of the relevant data of cutting/copying event occurs in itself is not less than the preset standard, the relevant data is written into the first OSS area associated with the first working party in response to the data upload instruction, so as to trigger the first OSS area to copy the relevant data into the second OSS area associated with the second working party through the global transit center.

In an embodiment, the global transit center sends the upload record information of the relevant data to the cloud clipboard management and control center. The processor 61 may also be used to:
in a case of receiving the second event information, determine whether there is upload record information in the relevant data corresponding to the second event information, and if yes, skip sending data upload instruction to the first working party.

In an embodiment, the second working party writes the obtained relevant data into the local system clipboard cache to complete the pasting.

Further, as shown in FIG. 6, the cloud clipboard management and control device further includes other components such as a power supply component 63. Only parts of the components are shown schematically in FIG. 6, which does not mean that the cloud clipboard management device only includes the components shown in FIG. 6.

It is worth noting that the technical details of the above-mentioned embodiments of the cloud clipboard management and control device can refer to the relevant descriptions of the cloud clipboard management and control center in the above-mentioned system embodiments, which are not repeated here for the sake of conciseness, but this should not cause any loss of the protection scope of this application.

FIG. 7 is a structural schematic diagram of a computing device provided by another exemplary embodiment of the present application. As shown in FIG. 7, the computing device includes a memory 70, a processor 71, and a communication component 72.

A processor 71, coupled with the memory 70 and the communication component 72, is used for executing a computer program in the memory 70 for:
sending first event information to the cloud clipboard management and control center in a cloud clipboard system through the global transit center under the condition that the cutting/copying event which occurs in itself is monitored, so that the cloud clipboard management and control center pushes the received first event information to other computing device in the user workspace of the cloud clipboard system through the global transit center;
using the cloud clipboard management and control center and the global transit center to provide the relevant data corresponding to the first event information to the computing device in the user workspace where the pasting event occurs, so as to complete the pasting;
sending second event information to the cloud clipboard management and control center through the global transit center under the condition that the pasting event which occurs in itself is monitored, so that the cloud clipboard management and control center copies the relevant data of the computing device where the cutting/copying event occurs in the user workspace to the current computing device to complete pasting;
where the plurality of computing devices in the user workspace are accessible to each other through the global transit center, and the types of the computing devices comprise a physical terminal and/or a cloud instance.

In an embodiment, a cloud clipboard proxy service is deployed in the computing device, and the computing device uses its own cloud clipboard proxy service to monitor cutting/copying event and the pasting event which occur in itself.

In an embodiment, if the computing device is a cloud instance, the process of the computing device monitoring the cutting/copying event and the pasting event which occur in itself includes:
receiving operation data synchronized by an interface display terminal connected with a computing device, wherein the operation data is generated by a user manipulating peripherals of the interface display terminal, and the interface display terminal is a physical terminal;
using the cloud clipboard proxy service to perceive that the manipulation data contains cutting/copying behavior data, and determining that a cutting/copying event occurs in the computing device;
using the cloud clipboard proxy service to perceive that the operation data includes pasting behavior data, and determining that a pasting event occurs in the computing device.

In an embodiment, if the first computing device is a physical terminal, the second computing device is a cloud instance, and the first computing device serves as an interface display terminal of the second computing device. And the first computing device is used for:
sending the first event information to the cloud clipboard management and control center through the global transit center to push the first event information to the second computing device under the condition of monitoring that the user executes the cutting/copying behavior outside the display interface of the second computing device through its a peripheral;
in the case of monitoring that the user performs pasting behavior within the display interface of the second computing device through it's a peripheral, synchronizing the operation data including pasting behavior data to the second computing device, so that the second computing device monitors the pasting event that occurs in itself and triggers the pasting of local data of the first computing device into the second computing device by sending second event information to the cloud clipboard management and control center.

In an embodiment, in a process of sending the first event information to the cloud clipboard management and control center through the global transit center, the processor 71 is configured for:
sending the first event information to a message queue under a message topic associated with the computing device so as to transmit the first event information to the global transit center, where the global transit center has subscribed to the message topic;
where the cloud clipboard management and control center provides the routing information of other computing devices in the user workspace to the global transit center, the global transit center is used to route the first event information to the message queues under the message topics associated with other computing devices, so that other computing devices receive the first event information by subscribing to the message topic.

In an embodiment, message topics are deployed in different regions, and computing devices are associated with the message topics deployed in regions where the computing devices are located, and multiple computing devices can be distributed in regions not exactly the same.

In an embodiment, after receiving the second event information, the cloud clipboard management and control center sends a data upload instruction to the current computing device through the global transit center, so as to trigger the current computing device to write relevant data into its associated first storage location; copying the relevant data in the first storage location to a second storage location associated with the computing device that sends the second event information through the global transit center; sending a data download instruction to the computing device through the global transit center to trigger the computing device to download relevant data from its associated second storage location.

In an embodiment, the first storage location is the object storage OSS area set in the region where the current computing device is located or the message queue under the first message topic associated with the first computing device. The second storage location is the object storage OSS area set in the region where the computing device that initials the second event information is located or the message queue under the second message topic associated with the second computing device.

In an embodiment, the processor 71 is further configured for:
if the specification of the relevant data of cutting/copying event which occurs in itself is less than a preset standard, writing the relevant data into the message queue under the first message topic associated with the first computing device in response to the data upload instruction, so as to transfer the relevant data to the message queue under the second message topic associated with the second computing device through the cloud clipboard management and control center and the global transit center;
if the specification of the relevant data of cutting/copying event which occurs in itself is not less than the preset standard, writing the relevant data into the first OSS area associated with the first computing device in response to the data upload instruction, so as to trigger the first OSS area to copy the relevant data into the second OSS area associated with the second computing device through the global transit center.

In an embodiment, the global transit center sends the upload record information of the relevant data to the cloud clipboard management and control center. In a case of receiving the second event information, the cloud clipboard management and control center determines whether there is upload record information in the relevant data corresponding to the second event information, and if yes, skipping sending data upload instruction to the first computing device.

In an embodiment, the processor 71 is further configured for:
after receiving the event information corresponding to the cutting/copying event sent by other computing devices, starting a callback function for the pasting event;
triggering a callback function in response to the pasting operation which occurs in the current computing device to generate event information corresponding to the pasting event.

In an embodiment, the processor 71 is further configured for:
if a pasting event occurs in the current computing device, writing the obtained relevant data into the local system clipboard cache to complete the pasting.

Further, as shown in FIG. 7, the computing device also includes a display 73, a power supply component 74, an audio component 75 and other components. Only parts of the components are shown schematically in FIG. 7, which does not mean that the computing device only includes the components shown in FIG. 7.

It is worth noting that the above technical details in various embodiments of the computing device can be referred to the relevant descriptions of the first computing device/second computing device in the aforementioned system embodiments, which are not repeated here for the sake of conciseness, but this should not cause any loss of the protection scope of this application.

Correspondingly, the embodiments of the application also provides a computer-readable storage medium storing a computer program, and when the computer program is executed, the steps that can be executed by the cloud clipboard management and control device or the computing device in the above method embodiment can be implemented.

The above-mentioned memories in FIG. 6 and FIG. 7 are used to store computer programs and can be configured to store various other data to support operations on the computing platform. Examples of such data include instructions for any application or method operating on the computing platform, contact data, phone book data, messages, pictures, videos, and the like. The memory can be realized by any type of volatile or nonvolatile memory device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disc.

The communication components in FIG. 6 and FIG. 7 are configured to facilitate wired or wireless communication between the device where the communication component is located and other devices. The device where the communication component is located can access wireless networks based on communication standards, such as WiFi, mobile communication networks such as 2G, 3G, 4G/LTE, 5G, or their combination. In an exemplary embodiment, the communication component receives a broadcast signal or broadcast related information from an external broadcast management system via a broadcast channel. In an exemplary embodiment, the communication component further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

The above-mentioned display in FIG. 7 includes a screen, and the screen may include a liquid crystal display (LCD) and a touch panel (TP). If the screen includes a touch panel, the screen may be implemented as a touch screen to receive an input signal from a user. The touch panel includes one or more touch sensors to sense touch, sliding and gestures on the touch panel. The touch sensor may not only sense the boundary of a touch or sliding action, but also detect a duration and pressure related to the touch or the sliding operation.

The above-mentioned power supply components in FIG. 6 and FIG. 7 provide power for various components of the device where the power supply components are located. Power components can include a power management system, one or more power supplies, and other components associated with generating, managing and distributing power for the device where the power components are located.

The above-mentioned audio component in FIG. 7 can be configured to output and/or input audio signals. For example, the audio component includes a microphone (MIC), which is configured to receive external audio signals when the device in which the audio component is located is in operation modes, such as call mode, recording mode and voice recognition mode. The received audio signal may be further stored in a memory or transmitted via a communication component. In some embodiments, the audio assembly further includes a speaker for outputting audio signals.

It should be understood by those skilled in the art that embodiments of the present application can be provided as a method, a system, or a computer program product. Therefore, this application can take the form of an entirely hardware embodiment, an entirely software embodiment, or an embodiment combining software and hardware aspects. Moreover, this application can take the form of a computer program product implemented on one or more computer-usable storage media (including but not limited to disk storage, CD-ROM, optical storage, etc.) containing computer-usable program codes.

The present application is described with reference to flowcharts and/or block diagrams of methods, devices (systems), and computer program products according to embodiments of the present application. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, special-purpose computer, embedded processor or other programmable data processing apparatus to produce a machine, such that the instructions which are executed by the processor of the computer or other programmable data processing apparatus produce means for implementing the functions as specified in one or more flows in the flowchart and/or one or more blocks in the block diagram.

These computer program instructions may also be stored in a computer-readable memory that can direct a computer or other programmable data processing apparatus to function in a particular manner, such that the instructions stored in the computer-readable memory produce an article of manufacture including instruction means that implement the functions as specified in one or more flows in the flowchart and/or one or more blocks in the block diagram.

These computer program instructions may also be loaded onto a computer or other programmable data processing apparatus, such that a series of operational steps are performed on the computer or other programmable apparatus to produce a computer-implemented process, such that the instructions executed on the computer or other programmable apparatus provide steps for implementing the functions as specified in one or more flows in the flowchart and/or one or more blocks in the block diagram.

In a typical configuration, a computing device includes one or more processors (CPU), input/output interfaces, network interfaces, and memory.

Memory may include non-permanent memory, random access memory (RAM) and/or nonvolatile memory in computer-readable media, such as read-only memory (ROM) or flash memory. Memory is an example of a computer-readable medium.

Computer-readable media, including permanent and non-permanent, removable and non-removable media, can realize information storage by any method or technology. Information can be computer-readable instructions, data structures, modules of programs or other data. Examples of storage media for computers include, but not limited to phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, Compact Disc Read-Only Memory (CD-ROM), and digital versatile disc (DVD), or other optical storage, magnetic cassettes, magnetic tape disk storage or other magnetic storage devices or any other non-transmission medium, can be used to store information that can be accessed by computing devices. According to the definition in this paper, computer-readable media does not include temporary computer-readable media (transitory media), such as modulated data signals and carrier waves.

It should also be noted that the terms “including”, “comprising” or any other variation thereof are intended to cover non-exclusive inclusion, so that a process, method, commodity or device including a series of elements includes not only those elements, but also other elements not explicitly listed, or elements inherent to such process, method, commodity or device. Without more restrictions, an element defined by the phrase “including a” does not exclude the existence of other identical elements in the process, method, commodity or device including the element.

The above is only embodiments of the present application, and is not used to limit this application. Various modifications and variations will occur to those skilled in the art. Any modification, equivalent substitution, improvement, etc. made within the spirit and principle of this application shall be included in the protection scope of this application.

1. A cloud clipboard system, comprising a cloud clipboard management and control center and a plurality of working parties in a user workspace, wherein the plurality of working parties are accessible to each other through a global transit center;
a first working party in the plurality of working parties, configured to send first event information to the cloud clipboard management and control center through the global transit center in a case that a cutting/copying event which occurs in itself is monitored;
a second working party in the plurality of working parties, configured to send second event information to the cloud clipboard management and control center through the global transit center in a case that a pasting event which occurs in itself is motored after receiving the first event information;
the cloud clipboard management and control center, configured to push received first event information to other working parties except the first working party in the user workspace through the global transit center; in a case that the second event information is received, use the global transit center to copy relevant data in the first working party to the second working party for the second working party to complete pasting;
wherein types of the working parties comprise a physical terminal and/or a cloud instance.

2. The system according to claim 1, wherein a cloud clipboard proxy service is deployed in the working party, and if the working party is a cloud instance, the process for the working party to monitor a cutting/copying event and a pasting event occurring in itself comprises:
receiving operation data synchronized by an interface display terminal connected with the working party, wherein the operation data is generated by a user manipulating peripherals of the interface display terminal, and the interface display terminal is the physical terminal;
in case that the cloud clipboard proxy service perceives that the operation data comprises cutting/copying behavior data, determining that the cutting/copying event occurs in the working party;
in a case that the cloud clipboard proxy service perceives that the operation data comprises pasting behavior data, determining that the pasting event occurs in the working party.

3. The system according to claim 2, wherein if the first working party is the physical terminal, the second working party is the cloud instance, and the first working party serves as the interface display terminal of the second working party, the first working party is configured for:
sending first event information to the cloud clipboard management and control center through the global transit center to push the first event information to the second working party in a case of monitoring that the user performs a cutting/copying behavior outside the display interface of the second working party through its a peripheral;
in the case of monitoring that the user performs a pasting behavior within the display interface of the second working party through it's a peripheral, synchronizing the operation data comprising pasting behavior data to the second working party, so that the second working party monitors the pasting event that occurs in itself and triggers the pasting of the local data of the first working party into the second working party by sending the second event information to the cloud clipboard management and control center.

4. The system according to claim 1, wherein in the process of sending the first event information to the cloud clipboard management and control center through the global transit center, the first working party is configured for:
sending the first event information to a message queue under a first message topic associated with the first working party to transmit the first event information to the global transit center, where the global transit center has subscribed to the first message topic;
in the process of pushing the received first event information to other working parties except the first working party in the user workspace through the global transit center, the cloud clipboard management and control center is configured for:
generating routing information for the other working parties in the user workspace and providing the routing information to the global transit center;
using the global transit center to route the first event information to the message queue under the message topic associated with other working parties according to the routing information, so that the other working parties receive the first event information in a manner of subscribing to the message topic.

5. The system according to claim 4, message topics are respectively deployed in different regions, the working parties are associated with the message topics deployed in regions where the working parties are located, and the plurality of working parties are distributed in regions not exactly the same.

6. The system according to claim 1, wherein the second working party is further configured for:
starting a callback function for the pasting event after receiving the first event information;
triggering the callback function to generate the second event information under a condition that the pasting event which occurs in itself is monitored.

7. The system according to claim 1, in a case that the second event information is received, in a process of using the global transit center to copy the relevant data in the first working party to the second working party, the cloud clipboard management and control center is configured for:
sending a data upload instruction to the first working party through the global transit center to trigger the first working party to write the relevant data into its associated first storage location;
copying the relevant data in the first storage location to a second storage location associated with the second working party through the global transit center;
sending a data download instruction to the second working party through the global transit center to trigger the second working party to download the relevant data from its associated second storage location.

8. The system according to claim 7, wherein the first storage location is an object storage OSS area set in the region where the first working party is located or a message queue under the first message topic associated with the first working party; the second storage location is an object storage OSS area set in the region where the second working party is located or a message queue under a second message topic associated with the second working party.

9. The system according to claim 8, wherein the first working party is further configured for:
if a specification of the relevant data of cutting/copying event which occurs in itself is less than a preset standard, writing the relevant data into the message queue under the first message topic associated with the first working party in response to the data upload instruction, so as to transfer the relevant data to the message queue under the second message topic associated with the second working party through the cloud clipboard management and control center and the global transit center;
if the specification of the relevant data of cutting/copying event occurs in itself is not less than the preset standard, writing the relevant data into a first OSS area associated with the first working party in response to the data upload instruction, so as to trigger the first OSS area to copy the relevant data into a second OSS area associated with the second working party through the global transit center.

10. The system according to claim 7, wherein the global transit center is further used for: sending upload record information of the relevant data to the cloud clipboard management and control center;
the cloud clipboard management and control center is further configured for: upon receiving the second event information, determining whether there is upload record information in the relevant data corresponding to the second event information, and if yes, skip sending the data upload instruction to the first working party.

11. A cloud clipboard implementation method, applied to a cloud clipboard management and control device in a cloud clipboard system, wherein the cloud clipboard system further comprises a plurality of working parties in a user workspace, and the plurality of working parties are accessible to each other through a global transit center, the method comprises the following steps:
receiving first event information sent by a first working party of the plurality of working parties through the global transit center, wherein the first event information is sent by the first working party under a condition that a cutting/copying event which occurs in itself is monitored;
pushing the received first event information to other working parties except the first working party in the user workspace through the global transit center;
receiving second event information sent by a second working party of the plurality of working parties through the global transit center, wherein the second event information is sent by the second working party under a condition that a pasting event which occurs in itself is monitored;
in a case of receiving the second event information, using the global transit center to copy the relevant data in the first working party to the second working party for the second working party to complete pasting;
wherein, types of the working parties include a physical terminal and/or a cloud instance.

12. A cloud clipboard implementation method, applied to a plurality of working parties in a user workspace of a cloud clipboard system, wherein the plurality of working parties are accessible to each other through a global transit center, and the cloud clipboard system further comprises a cloud clipboard management and control device, the method comprises the following steps:
sending first event information to a cloud clipboard management and control center through the global transit center under a condition that a cutting/copying event which occurs in itself is monitored, so that the cloud clipboard management and control center pushes received first event information to other working parties in the user workspace through the global transit center;
using the cloud clipboard management and control center and the global transit center to provide relevant data corresponding to the first event information to a working party in the user workspace where a pasting event occurs, so as to complete the pasting;
sending second event information to the cloud clipboard management and control center through the global transit center under a condition that the pasting event which occurs in itself is monitored, so that the cloud clipboard management and control center copy the relevant data of the working party in the user workspace where the cutting/copying event occurs to the current working party to complete pasting;
wherein, types of the working parties comprise a physical terminal and/or a cloud instance.

13. A cloud clipboard management and control device, comprising a memory, a processor and a communication component;
the memory is used for storing one or more computer instructions;
the processor is coupled with the memory and the communication component for executing the one or more computer instructions to implement the method according to claim 11.

14. A computing device comprising a memory, a processor and a communication component;
the memory is used for storing one or more computer instructions;
the processor is coupled with the memory and the communication component for executing the one or more computer instructions to implement the method according to claim 12.

15. A non-transitory computer-readable storage medium storing computer instructions which, when executed by one or more processors, cause the one or more processors to execute the cloud clipboard implementation method according to claim 11.

16. A non-transitory computer-readable storage medium storing computer instructions which, when executed by one or more processors, cause the one or more processors to execute the cloud clipboard implementation method according to claim 12.

17. The cloud clipboard implementation method according to claim 11, the pushing the received first event information to other working parties except the first working party in the user workspace through the global transit center specifically comprises:
generating routing information for the other working parties in the user workspace and providing the routing information to the global transit center;
using the global transit center to route the first event information to the message queue under the message topic associated with other working parties according to the routing information, so that the other working parties receive the first event information in a manner of subscribing to the message topic.

18. The cloud clipboard implementation method according to claim 11, wherein in a case that the second event information is received, the process of using the global transit center to copy the relevant data in the first working party to the second working party comprises:
sending a data upload instruction to the first working party through the global transit center to trigger the first working party to write the relevant data into its associated first storage location;
copying the relevant data in the first storage location to a second storage location associated with the second working party through the global transit center;
sending a data download instruction to the second working party through the global transit center to trigger the second working party to download the relevant data from its associated second storage location.

19. The cloud clipboard implementation method according to claim 12, wherein a cloud clipboard proxy service is deployed in the working party, and if the working party is a cloud instance, the process for the working party to monitor a cutting/copying event and a pasting event occurring in itself comprises:
receiving operation data synchronized by an interface display terminal connected with the working party, wherein the operation data is generated by a user manipulating peripherals of the interface display terminal, and the interface display terminal is the physical terminal;
in case that the cloud clipboard proxy service perceives that the operation data comprises cutting/copying behavior data, determining that the cutting/copying event occurs in the working party;
in a case that the cloud clipboard proxy service perceives that the operation data comprises pasting behavior data, determining that the pasting event occurs in the working party.

20. The cloud clipboard implementation method according to claim 12, wherein if the first working party is the physical terminal, the second working party is the cloud instance, and the first working party serves as the interface display terminal of the second working party, the first working party is configured for:
sending first event information to the cloud clipboard management and control center through the global transit center to push the first event information to the second working party in a case of monitoring that the user performs a cutting/copying behavior outside the display interface of the second working party through its a peripheral;
in the case of monitoring that the user performs a pasting behavior within the display interface of the second working party through it's a peripheral, synchronizing the operation data comprising pasting behavior data to the second working party, so that the second working party monitors the pasting event that occurs in itself and triggers the pasting of the local data of the first working party into the second working party by sending the second event information to the cloud clipboard management and control center.
